(19) United States
(12) Patent Application Publication
(10) Pub. No.: US 2025/0291483 A1
(43) Pub. Date: Sep. 18, 2025

(54) METHOD OF MEMORY OPERATION, ELECTRONIC DEVICE AND NON-TRANSITORY COMPUTER-READABLE MEDIUM

(71) Applicant: Realtek Semiconductor Corporation, Hsinchu (TW)

(72) Inventor: Kai-Hsiang CHOU, Hsinchu (TW)

(21) Appl. No.: 18/909,959

(22) Filed: Oct. 9, 2024

(30) Foreign Application Priority Data
Mar. 12, 2024 (TW) 113109065

(51) Int. Cl. G06F 3/06

(52) U.S. Cl. CPC G06F 3/0608; G06F 3/0659; G06F 3/0683

(57) ABSTRACT

A method of memory operation includes using a compression algorithm to compress at least one application in a non-volatile memory into at least one compressed format file; preloading the at least one compressed format file from the non-volatile memory into a compressed data area of a volatile memory; obtaining an image of the compressed data area based on the at least one compressed format file preloaded into the compressed data area, and storing the image back to the non-volatile memory; and decompressing the at least one compressed format file into the at least one application.

### RELATED APPLICATIONS

This application claims priority to Taiwan Application Serial Number 113109065, filed on Mar. 12, 2024, which is herein incorporated by reference.

### BACKGROUND

In applications such as over-the-top (OTT) services and digital video set-up-box (STB), the speed of opening an application often affects the user experience. Generally speaking, in order to speed up the opening of applications, it is now more common practice to preload relatively frequently used and relatively important applications into high-speed memory, such as double data rate synchronous dynamic random access memory (DDR SDRAM). However, as costs increase and memory specifications shrink (such as memory capacity reduction), the number of applications that can be preloaded into the memory is further reduced. If an application cannot be preloaded into memory, it must be loaded from non-volatile memory into high-speed memory after the user clicks on the application. With today's technology, it takes about 1 to 2 seconds to preload an application into high-speed memory and open it (i.e., open it for the second time), while it takes about 7 to 8 seconds to load the same application from non-volatile memory (i.e., open it for the first time). Hence, there is a significant difference in how long the two methods take to load applications into memory.

### SUMMARY

One aspect of the present disclosure relates to a memory operation method, which includes using a compression algorithm to compress at least one application in a non-volatile memory into at least one compressed format file; preloading the at least one compressed format file from the non-volatile memory into a compressed data area in a volatile memory; obtaining an image of the compressed data area based on the at least one compressed format file preloaded into the compressed data area, and writing back the image to the non-volatile memory; and decompressing the at least one compressed format file into the at least one application in the volatile memory.

In accordance with one or more embodiments of the present disclosure, the non-volatile memory complies with the eMMC (Embedded MultiMediaCard) flash memory standard.

In accordance with one or more embodiments of the present disclosure, the compression algorithm is an LZ4 compression algorithm, an LZO compression algorithm or a zlib compression algorithm.

In accordance with one or more embodiments of the present disclosure, the memory operation method further includes removing at least one library shared by the at least one application after preloading each of the at least one compressed format file of the at least one application into the compressed data area in the volatile memory.

In accordance with one or more embodiments of the present disclosure, the operation of removing the at least one library shared by the at least one application is performed offline.

In accordance with one or more embodiments of the present disclosure, the memory operation method further includes reducing the compressed data area before obtaining the image of the compressed data area based on the at least one compressed format file preloaded into the compressed data area.

In accordance with one or more embodiments of the present disclosure, the operation of reducing the compressed data area is performed offline.

In accordance with one or more embodiments of the present disclosure, the operation of loading the at least one compressed format file from the non-volatile memory into the compressed data area in the volatile memory is performed offline.

In accordance with one or more embodiments of the present disclosure, the operation of obtaining the image of the compressed data area based on the at least one compressed format file loaded into the compressed data area is performed offline.

Another aspect of the present disclosure relates to an electronic device, which includes a non-volatile memory, a volatile memory, and a processor. The non-volatile memory is configured to store at least one application. The volatile memory is configured to store at least one compressed format file, wherein the volatile memory further includes a compressed data area. The processor is configured to use a compression algorithm to compress the at least one application in the non-volatile memory into the at least one compressed format file, and preload the at least one compressed format file from the non-volatile memory into the compressed data area in the volatile memory, and write back the image to the non-volatile memory after obtaining the image of the compressed data area based on the at least one compressed format file preloaded into the compressed data area, and then decompress the at least one compressed format file in the volatile memory into the at least one application.

In accordance with one or more embodiments of the present disclosure, the non-volatile memory is a flash memory.

In accordance with one or more embodiments of the present disclosure, the volatile memory is double data rate synchronous dynamic random access memory (DDR SDRAM).

In accordance with one or more embodiments of the present disclosure, the compression algorithm is an LZ4 compression algorithm, an LZO compression algorithm or a zlib compression algorithm.

In accordance with one or more embodiments of the present disclosure, the processor is further configured to remove at least one library shared by the at least one application after preloading each of the at least one compressed format file of the at least one application into the compressed data area in the volatile memory.

In accordance with one or more embodiments of the present disclosure, the processor removes the at least one library shared by the at least one application while in an offline state.

In accordance with one or more embodiments of the present disclosure, the processor is further configured to reduce the compressed data area before obtaining the image of the compressed data area based on the at least one compressed format file preloaded into the compressed data area.

In accordance with one or more embodiments of the present disclosure, the processor reduces the compressed data area while in an offline state.

In accordance with one or more embodiments of the present disclosure, the processor is configured to load the at least one compressed format file from the non-volatile memory into the compressed data area in the volatile memory while in an offline state.

In accordance with one or more embodiments of the present disclosure, the processor is configured to obtain the image of the compressed data area based on the at least one compressed format file loaded into the compressed data area.

Yet another aspect of the present disclosure relates to a non-transitory computer-readable medium used to store one or more computer program instructions. When the computer program instructions are executed by a processor, the processor performs operations of using a compression algorithm to compress at least one application in a non-volatile memory into at least one compressed format file; preloading the at least one compressed format file from the non-volatile memory into a compressed data area in a volatile memory; obtaining an image of the compressed data area based on the at least one compressed format file preloaded into the compressed data area, and writing back the image to the non-volatile memory; and decompressing the at least one compressed format file into the at least one application in the volatile memory.

### BRIEF DESCRIPTION OF THE DRAWINGS

This disclosure can be more fully understood by reading the following detailed description of the embodiments, with reference made to the accompanying drawings as follows:

FIG. 1 is a flow chart of a memory operation method in accordance with some embodiments of the present disclosure.

FIG. 2 is a flow chart of a system on a chip software startup method in accordance with some embodiments of the present disclosure.

FIG. 3 is a functional block diagram of an electronic device in accordance with some embodiments of the present disclosure.

### DETAILED DESCRIPTION

Reference will now be made in detail to the present embodiments of this disclosure, examples of which are illustrated in the accompanying drawings. Wherever possible, the same reference numbers are used in the drawings and the description to refer to the same or like parts.

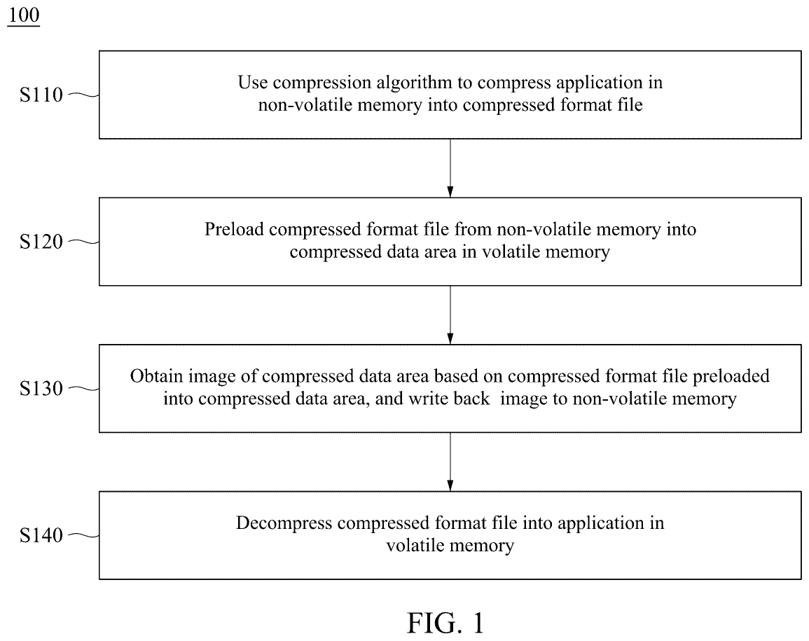

FIG. 1 is a flow chart of a memory operation method 100 in accordance with some embodiments of the present disclosure. The memory operation method 100 includes steps S110 to S140 described below.
Step S110: Use a compression algorithm to compress at least one application in a non-volatile memory into at least one compressed format file. This step illustrates that the processor uses a compression algorithm to compress relatively important and frequently used applications in a non-volatile memory into compressed format files, and stores the compressed format files in the non-volatile memory in a block-based form. It should be noted that the non-volatile memory complies with the eMMC (Embedded MultiMediaCard) flash memory standard. In one embodiment of the present disclosure, the compression algorithm may be an LZ4 compression algorithm, an LZO compression algorithm or a zlib compression algorithm, but is not limited thereto.
Step S120: Preload the at least one compressed format file from the non-volatile memory into a compressed data area in a volatile memory. This step illustrates that the processor preloads the compressed format files from the non-volatile memory into the compressed data area in the volatile memory, and then stores the compressed format files in the volatile memory in a page-based form. In one embodiment of the present disclosure, the operation of loading the compressed format files from the non-volatile memory into the compressed data area in the volatile memory by the processor can be performed offline.

In some embodiments, in order to improve the loading speed of preloading compressed format files from the non-volatile memory to the compressed data area in the volatile memory, a memory space can be reserved in the non-volatile memory (such as flash memory) for mapping to pages of the compressed data area in the volatile memory. Direct memory access (DMA) can be used to load the compressed format files into the compressed data area in the volatile memory during the loading process of the compressed format files. Compared with ordinary applications that are loaded from the non-volatile memory into the compressed data area of the volatile memory in blocks and executed by page in the volatile memory, loading the compressed format files into the compressed data area in the volatile memory through direct memory access can improve the loading speed of compressed format files of applications preloaded from the non-volatile memory into the volatile memory.

In some embodiments, when there is a complex set of frequently used applications, one or more compressed data areas (such as ZRAM) can be configured in the volatile memory for individual use by each set of the complex set of applications. Specifically, the processor will preload individual compressed format files from the non-volatile memory to individually configured compressed data areas in volatile memory for each set of applications.
Step S130: Obtain an image of the compressed data area based on the at least one compressed format file preloaded into the compressed data area, and write back the image to the non-volatile memory. This step illustrates that the processor obtains the image of the compressed data area based on the compressed format files preloaded into the compressed data area, and writes the image of the compressed data area back to the non-volatile memory for the next preloading of the same batch of frequently used applications. In some embodiments, the processor may not write the image back to the non-volatile memory.

In one embodiment of the present disclosure, the processor will remove at least one library shared by the at least one application to reduce the memory space repeatedly occupied by the applications after preloading each compressed format file into the compressed data area in the volatile memory. It should be noted that the operation of removing the at least one library shared by the at least one application by the processor is performed offline.

In another embodiment of the present disclosure, before obtaining the image of the compressed data area based on the compressed format files preloaded into the compressed data area, the processor will reduce the compressed data area to maximize the utilization of the compressed data area for saving the memory space of the volatile memory occupied by the compressed data area as much as possible. It should be noted that the operation of reducing the compressed data area by the processor is performed offline.

In yet another embodiment of the present disclosure, the operation of obtaining the image of the compressed data area based on the compressed format files loaded into the compressed data area by the processor is performed offline.

Generally speaking, the processor performs steps S110 to S130 while in an online state to obtain an image of the compressed data area in the volatile memory composed of compressed format files of frequently used applications. It should be noted that the processor can use a compression algorithm such as an LZ4 compression algorithm, an LZO compression algorithm or a zlib compression algorithm in the process of performing steps S110 to S130 online, but is not limited thereto. Further, the processor can also perform steps S110 to S130 while in an offline state. Specifically, while in an offline state, the processor can perform the operations of loading the compressed format files from the non-volatile memory to the compressed data area in the volatile memory, removing the library shared by the applications, reducing the compressed data area based on the compressed format files preloaded into the compressed data area, and obtaining the image of the compressed data area based on the compressed format files loaded into the compressed data area. The processor will reserve a memory space in the non-volatile memory for mapping to a compressed data area in the volatile memory, and when an electronic device (such as a smart phone, smart bracelet, tablet, etc.) is turned on, the processor will load the reserved memory space in the non-volatile memory into the volatile memory and create a compressed data area in volatile memory. Compared with loading while online, since the steps S110 to S130 are completed in the offline mode, the compression algorithm used is selected in the process of performing steps S110 to S130 while offline. It is noted that the loading speed of compressed format files of applications loaded by the processor while offline is faster than the loading speed of compressed format files of applications loaded by the processor while online.
Step S140: Decompress the at least one compressed format file into the at least one application in the volatile memory. Generally speaking, the processor decompresses the compressed format files in the non-volatile memory into applications and then loads the applications into the volatile memory during the runtime. In comparison, the method of preloading the compressed format files from non-volatile memory into the volatile memory and then decompressing the compressed format files into the applications in the volatile memory can significantly improve the loading speed of applications.

In one embodiment of the present disclosure, when the memory space available for the volatile memory (such as double data rate synchronous dynamic random access memory) is running out and the memory space in the compressed data area is needed, the processor will remove (swap out) the compressed format files of the applications that have not been used in the compressed data area for a long time. When the swapped out applications are needed again in the future, the processor compresses the swapped out applications into one or more compressed format files and preloads them into the compressed data area in the volatile memory again.

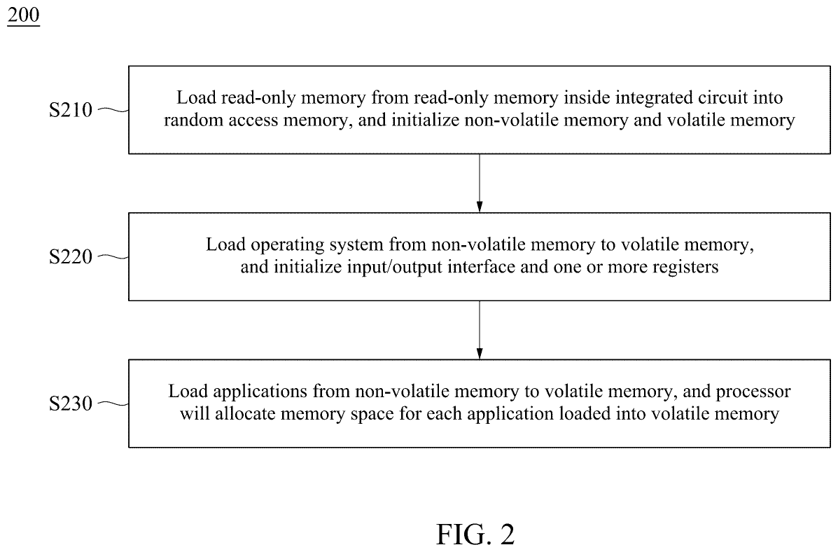

FIG. 2 is a flow chart of a system on a chip software startup method 200 in accordance with some embodiments of the present disclosure. Generally speaking, the system on a chip software startup method 200 includes steps S210 to S230 described below.
Step S210: Load the read-only memory from the read-only memory inside the integrated circuit (IC) into the random access memory, and initialize the non-volatile memory and the volatile memory. It should be noted that the non-volatile memory complies with the eMMC flash memory standard, while the volatile memory is double data rate synchronous dynamic random access memory (DDR SDRAM).
Step S220: Load the operating system from the non-volatile memory (such as flash memory) to the volatile memory (such as DDR SDRAM), and initialize an input/output (I/O) interface and one or more registers.
Step S230: Load applications from the non-volatile memory to the volatile memory, and the processor will allocate a memory space for each application loaded into the volatile memory.

The memory operation method 100 can be used to improve the loading speed of applications of the system on a chip software startup method 200, that is, to optimize loading applications from the non-volatile memory to the volatile memory in step S230 so as to improve the loading speed of applications. Specifically, a compression algorithm is first used to compress at least one application in the non-volatile memory into at least one compressed format file in step S110. Next, at least one compressed format file is preloaded from the non-volatile memory into the compressed data area in the volatile memory in step S120, after which the image of the compressed data area is obtained based on at least one compressed format file preloaded into the compressed data area, and the image is written back to the non-volatile memory in step S130. Lastly, at least one compressed format file is decompressed into at least one application program in the volatile memory in step S140. Therefore, through the operations from step S110 to step S140 of the memory operating method 100, these applications are compressed using a compression algorithm before execution and then loaded into the volatile memory, and the image of the compressed data area of the volatile memory is obtained so as to improve the loading speed of applications effectively, and the boot speed is faster than the general application loading method without preloading.

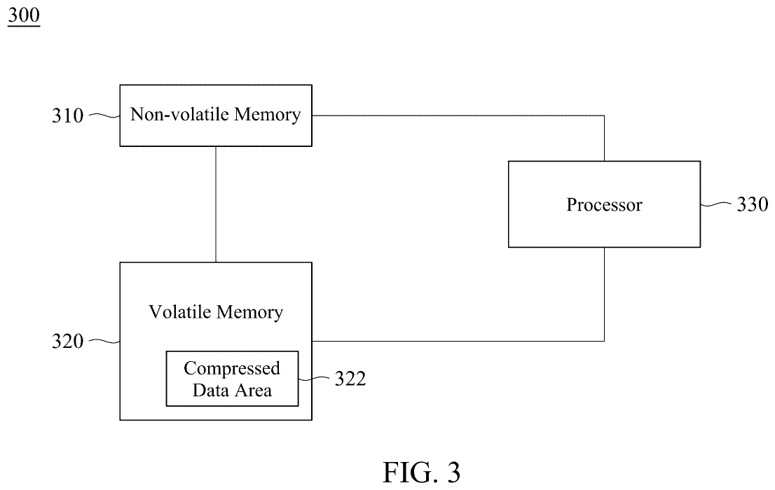

FIG. 3 is a functional block diagram of an electronic device 300 in accordance with some embodiments of the present disclosure. The electronic device 300 includes a non-volatile memory 310, a volatile memory 320 and a processor 330. The non-volatile memory 310 is configured to store at least one application. The non-volatile memory 310 may be a read-only memory (ROM), a programmable read-only memory (PROM), an electrically alterable read only memory (EAROM), an erasable programmable read only memory (EPROM), an electrically erasable programmable read only memory (EEPROM), a flash memory, a non-volatile random access memory (NVRAM), a battery-powered static random access memory or other similar components or a combination of the above components, but is not limited to thereto. The volatile memory 320 is configured to store at least one compressed format file, wherein the volatile memory 320 further includes a compressed data area 322. The volatile memory 320 may be a random access memory (RAM), such as a dynamic random access memory (DRAM), a static random access memory (SRAM), other similar elements or a combination of the above elements, but is not limited thereto. The processor 330 is configured to use a compression algorithm to compress the at least one application in the non-volatile memory 310 into the at least one compressed format file, and preload the at least one compressed format file from the non-volatile memory 310 into the compressed data area 322 in the volatile memory 320, and write back the image to the non-volatile memory 310 after obtaining the image of the compressed data area 322 based on the at least one compressed format file preloaded into the compressed data area 322, and then decompress the at least one compressed format file in the volatile memory 320 into the at least one application. The processor 330 may be a central processing unit (CPU), a graphics processing unit (GPU), a microcontroller unit (MCU), a microprocessor, a system-on-chip (SoC), a digital signal processor (DSP), an application-specific integrated circuit (ASIC), a programmable logic controller (PLC), or a combination of the above components, but is not limited thereto.

The processor 330 uses a compression algorithm to compress the relatively important and frequently used applications in the non-volatile memory 310 into compressed format files, and then stores the compressed format files in the non-volatile memory 310 in a block-based form. It should be noted that the non-volatile memory 310 complies with the eMMC flash memory standard. In one embodiment of the present disclosure, the compression algorithm may be an LZ4 compression algorithm, an LZO compression algorithm or a zlib compression algorithm, but is not limited thereto.

The processor 330 preloads the compressed format file from the non-volatile memory 310 into the compressed data area 322 in the volatile memory 320, and then stores the compressed format file in the volatile memory 320 in a page-based form. It should be noted that the volatile memory 320 is DDR SDRAM. In one embodiment of the present disclosure, the operation of loading the compressed format files from the non-volatile memory 310 into the compressed data area in the volatile memory 320 by the processor 330 can be performed offline.

In some embodiments, in order to improve the loading speed of preloading compressed format files from the non-volatile memory 310 to the compressed data area 322 in the volatile memory 320, a memory space can be reserved in the non-volatile memory 310 (such as flash memory) for mapping to pages of the compressed data area in the volatile memory 320. Direct memory access (DMA) can be used to load the compressed format files into the compressed data area 322 in the volatile memory 320 during the loading process of the compressed format files. Compared with ordinary applications that are loaded from the non-volatile memory 310 into the compressed data area 322 of the volatile memory 320 in blocks and executed by page in the volatile memory 320, loading the compressed format files into the compressed data area 322 in the volatile memory 320 through direct memory access can improve the loading speed of compressed format files of applications preloaded from the non-volatile memory 310 into the volatile memory 320.

In some embodiments, when there is a complex set of frequently used applications, one or more compressed data areas 322 (such as ZRAM) can be configured in the volatile memory 320 for individual use by each set of the complex set of applications. Specifically, the processor 330 will preload individual compressed format files from the non-volatile memory 310 to individually configured compressed data areas 322 in volatile memory 320 for each set of applications.

In one embodiment of the present disclosure, the processor 330 will remove at least one library shared by the at least one application to reduce the memory space repeatedly occupied by the applications after preloading each compressed format file into the compressed data area 322 in the volatile memory 320. It should be noted that the operation of removing the at least one library shared by the at least one application by the processor 330 is performed offline.

In another embodiment of the present disclosure, before obtaining the image of the compressed data area 322 based on the compressed format files preloaded into the compressed data area 322, the processor 330 will reduce the compressed data area 322 to maximize the utilization of the compressed data area 322 for saving the memory space of the volatile memory 320 occupied by the compressed data area 322 by as much as possible. It should be noted that the operation of reducing the compressed data area 322 by the processor 330 is performed offline.

In yet another embodiment of the present disclosure, the operation of obtaining the image of the compressed data area 322 based on the compressed format files loaded into the compressed data area 322 by the processor 330 is performed offline.

The memory operation method 100 can be programmed into computer program instructions, which can be executed by a processor (such as the processor 330 shown in FIG. 3) and can be stored in a non-transitory computer-readable medium. When the computer program instructions are executed by a processor, the processor performs operations of using a compression algorithm to compress at least one application in a non-volatile memory into at least one compressed format file; preloading the at least one compressed format file from the non-volatile memory into a compressed data area in a volatile memory; obtaining an image of the compressed data area based on the at least one compressed format file preloaded into the compressed data area, and writing back the image to the non-volatile memory; and decompressing the at least one compressed format file into the at least one application in the volatile memory. The non-transitory computer-readable medium can be a read-only memory, a non-volatile memory, floppy disks, hard disks, optical disks, a universal serial bus (USB), magnetic tapes, an internet-accessible database, or another computer-readable medium that would be obvious to a person of ordinary skill in the art.

As can be seen from the above description, the memory operating method and the electronic device of the present disclosure first use a compression algorithm to compress the application program into a compressed format file, and then preload the compressed format file from the non-volatile memory into the compressed data area in the volatile memory, after which the memory operating method and the electronic device obtain the image of the compressed data area and write the image back to the non-volatile memory for future reloading of the application. Through the above operations, those frequently used applications can be loaded into volatile memory at a faster speed and decompressed for execution under the condition of limited memory resources.

It will be apparent to those skilled in the art that various modifications and variations can be made to the structure of the present disclosure without departing from the scope or spirit of this disclosure. In view of the foregoing, it is intended that the present disclosure cover modifications and variations of this disclosure provided they fall within the scope of the following claims.

What is claimed is:

1. A memory operation method, comprising:
using a compression algorithm to compress at least one application in a non-volatile memory into at least one compressed format file;
preloading the at least one compressed format file from the non-volatile memory into a compressed data area in a volatile memory;
obtaining an image of the compressed data area based on the at least one compressed format file preloaded into the compressed data area, and writing back the image to the non-volatile memory; and
decompressing the at least one compressed format file into the at least one application in the volatile memory.

2. The memory operation method of claim 1, wherein the non-volatile memory complies with the eMMC (Embedded MultiMediaCard) flash memory standard.

3. The memory operation method of claim 1, wherein the compression algorithm is an LZ4 compression algorithm, an LZO compression algorithm or a zlib compression algorithm.

4. The memory operation method of claim 1, further comprising:
removing at least one library shared by the at least one application after preloading each of the at least one compressed format file of the at least one application into the compressed data area in the volatile memory.

5. The memory operation method of claim 4, wherein the operation of removing the at least one library shared by the at least one application is performed offline.

6. The memory operation method of claim 1, further comprising:
reducing the compressed data area before obtaining the image of the compressed data area based on the at least one compressed format file preloaded into the compressed data area.

7. The memory operation method of claim 6, wherein the operation of reducing the compressed data area is performed offline.

8. The memory operation method of claim 1, wherein the operation of loading the at least one compressed format file from the non-volatile memory into the compressed data area in the volatile memory is performed offline.

9. The memory operation method of claim 1, wherein the operation of obtaining the image of the compressed data area based on the at least one compressed format file loaded into the compressed data area is performed offline.

10. An electronic device, comprising:
a non-volatile memory configured to store at least one application;
a volatile memory configured to store at least one compressed format file, wherein the volatile memory further includes a compressed data area; and
a processor configured to use a compression algorithm to compress the at least one application in the non-volatile memory into the at least one compressed format file, and preload the at least one compressed format file from the non-volatile memory into the compressed data area in the volatile memory, and write back an image of the compressed data area to the non-volatile memory after obtaining the image of the compressed data area based on the at least one compressed format file preloaded into the compressed data area, and then decompress the at least one compressed format file in the volatile memory into the at least one application.

11. The electronic device of claim 10, wherein the non-volatile memory is a flash memory.

12. The electronic device of claim 10, wherein the volatile memory is double data rate synchronous dynamic random access memory (DDR SDRAM).

13. The electronic device of claim 10, wherein the compression algorithm is an LZ4 compression algorithm, an LZO compression algorithm or a zlib compression algorithm.

14. The electronic device of claim 10, wherein the processor is further configured to remove at least one library shared by the at least one application after preloading each of the at least one compressed format file of the at least one application into the compressed data area in the volatile memory.

15. The electronic device of claim 14, wherein the processor removes the at least one library shared by the at least one application while in an offline state.

16. The electronic device of claim 10, wherein the processor is further configured to reduce the compressed data area before obtaining the image of the compressed data area based on the at least one compressed format file preloaded into the compressed data area.

17. The electronic device of claim 16, wherein the processor reduces the compressed data area while in an offline state.

18. The electronic device of claim 10, wherein the processor is configured to load the at least one compressed format file from the non-volatile memory into the compressed data area in the volatile memory while in an offline state.

19. The electronic device of claim 10, wherein the processor is configured to obtain the image of the compressed data area based on the at least one compressed format file loaded into the compressed data area.

20. A non-transitory computer-readable medium used to store one or more computer program instructions, and when the computer program instructions are executed by a processor, the processor performs operations of:
using a compression algorithm to compress at least one application in a non-volatile memory into at least one compressed format file;
preloading the at least one compressed format file from the non-volatile memory into a compressed data area in a volatile memory;
obtaining an image of the compressed data area based on the at least one compressed format file preloaded into the compressed data area, and writing back the image to the non-volatile memory; and
decompressing the at least one compressed format file into the at least one application in the volatile memory.
